(19) United States
(12) Patent Application Publication
(10) Pub. No.: US 2002/0102064 A1
(43) Pub. Date: Aug. 1, 2002

(54) High speed optical intelligent switch

(76) Inventors: Jolanta I. Rosemeier, Phoenix, MD (US); Ronald G. Rosemeier, Phoenix, MD (US)

Correspondence Address: Max Stul Oppenheimer, P.O. Box 50, Stevenson, MD, 21153, US

(21) Appl. No.: 09/876,240

(22) Filed: Jun. 7, 2001

Related U.S. Application Data
(60) Provisional application No. 60/210,019, filed on Jun. 8, 2000.

(51) Int. Cl. G02B 6/38

(52) U.S. Cl. 385/70

(57) ABSTRACT

Optical intelligent switch utilizing one-dimensional, two-dimensional and multi-channel acousto-optic devices optically coupled to optical fibers provides an accurate, stable, high performance, high speed means for transferring and controlling the flow of information. Applications include intelligent switching of light in fiber optic communication systems.

This application is entitled to, and claims the benefit of, priority from U.S. Provisional Application Serial No. 60/210,019, filed Jun. 8, 2000 .

### FIELD AND BACKGROUND OF THE INVENTION

1. Field of the Invention

The present invention relates in general to optical switching.

2. Background Information

The invention described and claimed herein comprises a novel optical intelligent switch utilizing one-dimensional, two-dimensional and multi-channel acousto-optic devices optically coupled to optical fibers so as to provide an accurate, stable, high performance, high speed means for transferring and controlling the flow of information. Applications include intelligent switching of light in fiber optic communication systems.

Optical switch technology based on mechanical methods is inherently slower than the technology disclosed herein, and limited to a shorter lifetime of use because of their mechanical nature. Also mechanical methods are inherently sensitive to vibrations. Non-mechanical liquid crystal optical switches are faster than the conventional mechanical switches, but still remain orders of magnitude slower in switching speed compared to our novel acousto optic light switch. Both the liquid crystal optical switches, as well as another class of integrated electro optical switches which are inherently fast, generate polarized light in the fiber which may or may not be useful in certain switching applications.

### SUMMARY OF THE INVENTION

The foregoing problems are overcome, and other advantages are provided by a novel acousto-optic switch, in accordance with the invention, in which the light from a fiber optic is coupled into a specially configured acousto optic device, whereby a piezoelectric acoustic transducer or an array of N transducers generate sound waves in the device. The sound generated into the acousto optic device from the transducer interacts with the input light beam from the fiber. When the Bragg condition is satisfied, two light beams emerge from the acousto optic device. Both a reference light beam, which is coupled into the reference fiber, and a deflected light beam, which is coupled into the N switched fiber, are created thus making an optical light switch. By externally switching electrical energy or radio frequency (RF) into one of the appropriate transducers, light is switched from the input fiber to the corresponding N output fibers creating a rapid, non-mechanical optical light switch. By activating one or more of the transducers with RE power, multiple optical switching can be achieved simultaneously in the same acousto optic device.

By arranging numbers of N transducers on various faces of the acousto optic device, the number of N output light fibers also increases proportionally. Also, routing information can be placed on the light beam to be detected in the reference output light beam which gives information to the control electronics to activate the appropriate N transducer hence causing the light to be switched to a certain N output fiber.

It is an object of the invention to provide switching which is faster than conventional fiber optic switches.

It is another object of the invention to provide switching which is more reliable than conventional fiber optic switches.

It is another object of the invention to provide a device which does not suffer from inherent losses due to polarization.

It is another object of the invention to provide a method for switching which does not require mechanical moving parts.

The fundamental purpose of the invention is to provide an accurate, stable, high performance, high speed optical switch based upon specially configured acousto optic devices optically coupled with fibers that has the advantage of non-mechanical moving parts. By utilizing the output reference optical beam in these novel, configured acousto optic switches, information can be placed on the optical light signal to switch the light to the appropriate N output fiber in this intelligent optical switch configuration. Uses of these types of devices include intelligent switching of light in optical fiber optic communication network applications. The advantages of this invention include improved speed of switching light compared to the mechanical conventional and micro electronic mirror switch methods, and also the electro optic and liquid crystal methods. Also, compared to integrated electro optic device switching which generate polarized light, the acousto optic switch may or may not generate polarized light depending upon the acousto optic device configuration.

These and other objects, features and advantages which will be apparent from the discussion which follows are achieved, in accordance with the invention, by providing a novel acousto-optic switch, in accordance with the invention, in which the light from a fiber optic is coupled into a specially configured acousto optic device, whereby a piezoelectric acoustic transducer or an array of N transducers generate sound waves in the device.

The various features of novelty which characterize the invention are pointed out with particularity in the claims annexed to and forming a part of this disclosure. For a better understanding of the invention, its advantages and objects, reference is made to the accompanying drawings and descriptive matter in which a preferred embodiment of the invention is illustrated.

### BRIEF DESCRIPTION OF THE DRAWINGS

The foregoing and still other objects of this invention will become apparent, along with various advantages and features of novelty residing in the present embodiments, from study of the following drawings, in which:

FIG. 1 illustrates the basic configuration of the invention in a one dimensional optical switch.

FIG. 2 is a schematic illustration of the invention embodied as a 1×n optical switch.

FIG. 3 illustrates the basic configuration of the invention in a two-dimensional optical switch.

FIG. 4 illustrates the basic configuration of the invention in a two-dimensional, single-element multichannel optical switch.

FIG. 5 illustrates the basic configuration of a gang of various combinations of multielement N×N optical switches.

FIG. 6 is a schematic illustration of N×N interconnecting optical fiber switch.

FIG. 7 illustrates a specially configured acousto optic N×N interconnect optical switch.

FIG. 8 illustrates a single column N×N optical switch utilizing special acousto optic configuration.

### DESCRIPTION OF THE PREFERRED EMBODIMENT

The fundamental purpose of the invention is to provide an accurate, stable, high performance, high speed optical switch based upon specially configured acousto optic devices optically coupled with fibers that has the advantage of non-mechanical moving parts. By utilizing the output reference optical beam in these novel, configured acousto optic switches, information can be placed on the optical light signal to switch the light to the appropriate N output fiber in this intelligent optical switch configuration. Uses of these types of devices include intelligent switching of light in optical fiber optic communication network applications. The advantages of this invention include improved speed of switching light compared to the mechanical conventional and micro electronic mirror switch methods, and also the electro optic and liquid crystal methods. Also, compared to integrated electro optic device switching which generate polarized light, the acousto optic switch may or may not generate polarized light depending upon the acousto optic device configuration.

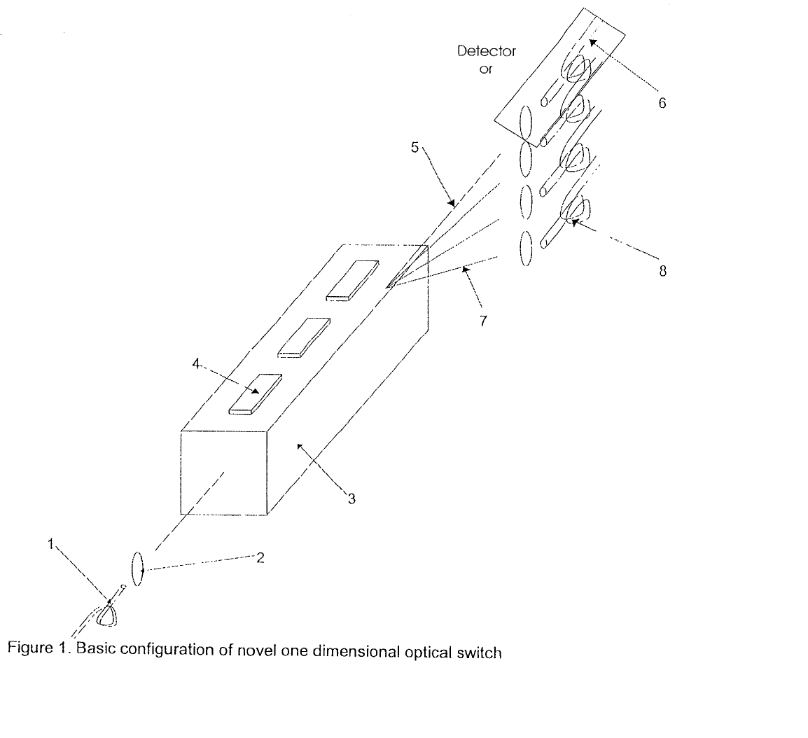

Referring to the drawings, the invention is a novel optical intelligent switch utilizing one-dimensional, two-dimensional and multi-channel acousto-optic devices optically coupled to optical fibers so as to provide an accurate, stable, high performance, high speed means for transferring and controlling the flow of information shown in overview in FIG. 1.

FIG. 1 depicts the schematic drawing of the invention for high speed switching of light in fiber optics utilizing specially configured acousto optic devices optically coupled to N fibers. The input fiber optic light source 1 is coupled via a lens 2 into the acousto optic device 3. The light interacts with the sound generated by the piezoelectric acoustic transducer 4 to create both a zero order light beam which acts as a reference light beam 5 into the reference fiber 6, and a deflected light beam 7 coupled via a lens into the N output fiber 8, hence defining the optical switch. The speed of deflecting the light beam or the optical switch is dependent upon the speed of sound in the acousto optic device, and the rate at which the RF signals are applied to the individual transducers on the acousto optic device. By applying RF electrical power to the individual transducers sequentially or randomly the switching of the light will be deflected respectively into the associated N output fibers. Increasing the number of N transducers along the longitudinal axis of the acousto optic substrate 3, also increases the number of N output deflected light beams proportionally. In all these specially configured acousto optic devices, routing information can be placed on the light beam to be detected in the reference light beam either with a detector or a fiber connected to a detector. This information from the detector is sent to the control electronics to activate the appropriate N transducer hence causing the light to be routed to a certain N output fiber or fibers.

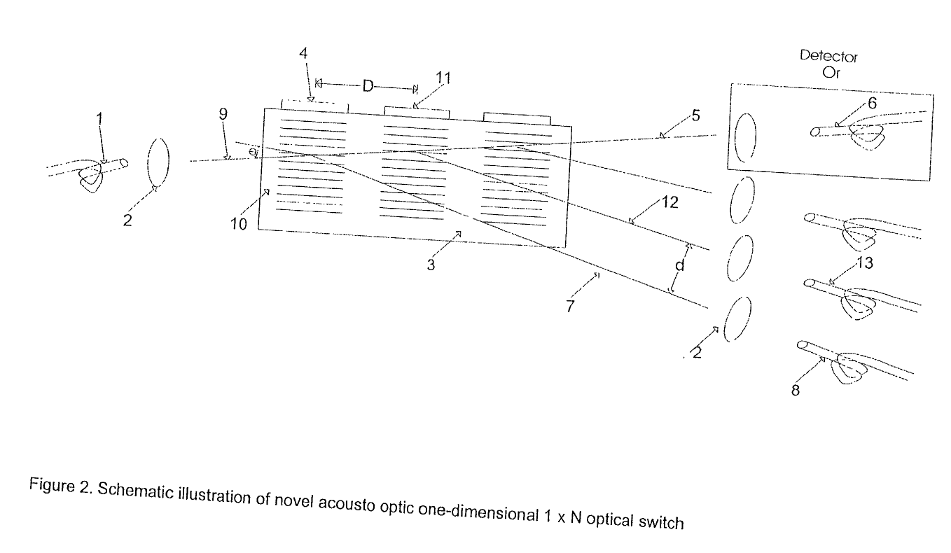

FIG. 2 illustrates the basic operational principle of a novel one-dimensional 1×N acousto optical switch in FIG. 1. The light emerging from the input fiber optic 1 is shaped by the lens 2 to form a light beam 9 in the acousto optic device, and when adjusted for the Bragg angle, θ, generates both a reference beam light 5 into the reference fiber 6 or a detector, and a deflected light beam 7 coupled into the N switching fiber 8 via the lens 2.

This information from the detector is sent to the control electronics to activate the appropriate N transducer hence causing the light to be routed to a certain N output fiber or fibers. The Bragg angle, θ, is defined by the angle between the input light beam 9 and the direction perpendicular to the sound wave direction generated by the acoustic transducer which satisfies the following equation:

Sin θ=(λf/(2v)

where λ is the optical wavelength, f is the RF frequency, and v is the velocity of sound in the acousto optic device material 3.

If the transducer 4 is activated with RF power an acoustic wave 10 will be generated inside the acousto optic device 3. The input light 9 interacts with sound wave 10 and most of the light energy is deflected along the path 7 into lens 2 and coupled to N output fiber 8. The amount of switched optical energy can be described by the following equation:

$${E}_{d} / {E}_{in} = {sin}^{2} ( \frac{Π}{Λ} \sqrt{(} {M}_{2} * P * L / 2 * H ) )$$

where: E_{d} is the intensity of the deflected beam, Eᵢₙ is the intensity of the input beam, M₂ is the acousto-optic figure of merit, P is the acoustic wave power, λ is the wavelength of light, and L and H are the length and width of transducer.

Also, by placing an array of multiple N transducers 4, 11, etc. along the side of the acousto optic device a multielement optical switch is created. The thickness of the array of transducers is appropriately adjusted to satisfy the Bragg condition of the incident light beam 9. By applying RF power to the transducers sequentially or randomly a novel, fast optical switch is created. Also, by applying RF power simultaneously to two or more of the transducers (i.e. 4, 11) the corresponding deflected light beams (i.e. 7, 12) will simultaneously switch the light into the corresponding N fibers 8, 13 generating redundant light beams. For example, if transducers 4 and 11 are activated simultaneously the redundant pair of N fibers 8 and 13 is also generated. Applications such as this may be useful for secure communication requirements. Another novel approach is to adjust the transducers to the same or similar frequencies; hence, the spacing “D” between transducers will correspond to the deflected light beams 7, 12 which will have a proportional displacement “d” between them which allows the light to be easily coupled into N fibers 8, 13. The displacement, d, of the output fibers is proportional to the Bragg angle, θ, RF frequency, f and the spacing, D between transducers.

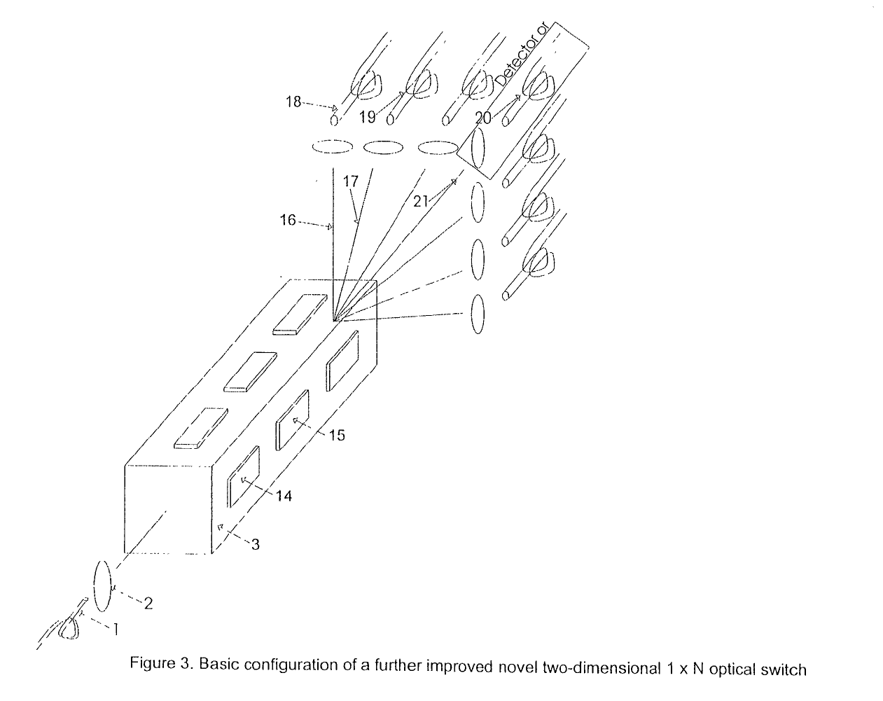

FIG. 3 illustrates a schematic of further novel improvement of the performance of the novel optical switch by applying another one or a multiple array of transducers 14, 15, etc. along the adjacent surface of the acousto optic device 3. The increase of the number of N transducers generates another array of light beams 16, 17 coupled into the N output fibers 18, 19 which significantly increases the number of switching elements on the same bulk acousto optic switching device. Also in this configuration the reference light beam 21 can carry information about the routing of the light which is common to all the N output fibers 18, 19, etc. Similarly in this specially configured acousto optic device routing information can be placed on the light beam to be detected in the reference light beam either with a detector or a fiber 20, connected to a detector. This information from the detector is sent to the control electronics to activate the appropriate N transducer hence causing the light to be routed to a certain N output fiber or fibers.

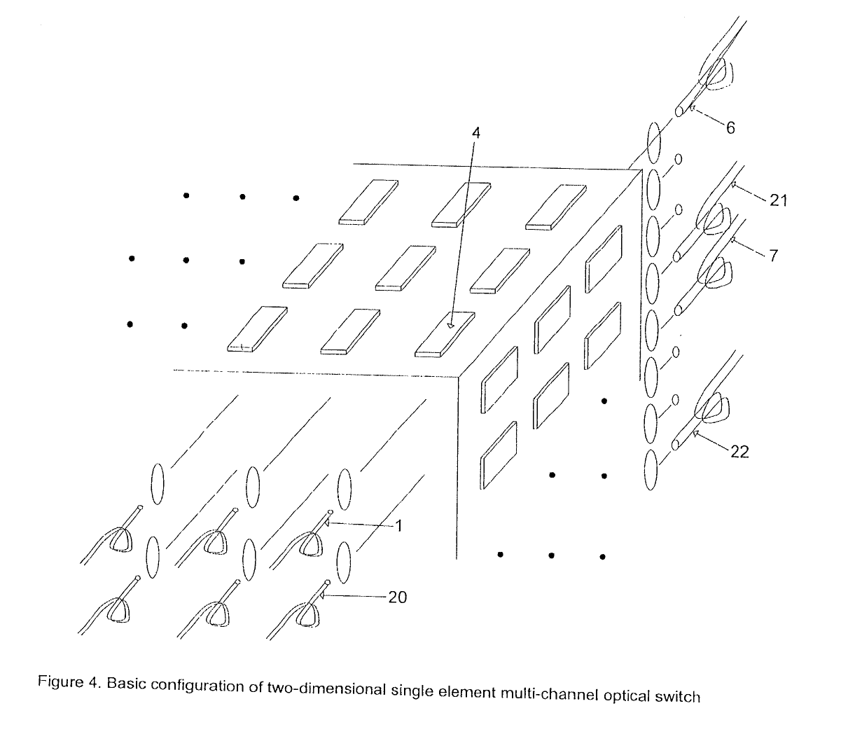

FIG. 4 illustrates a further novel improvement of the optical switch by further increasing the number of transducers on both faces of the acousto optic device to significantly increase both the number of N input fibers and corresponding N output fibers. Hence, by increasing the number of N fiber optic inputs on the front surface of the acousto optic, the N output light fibers are proportionally increased by the increased number of transducers. For example, along a row of two input fiber optic fibers 1, 20 under a single transducer 4 which is activated with RF power for example two output fibers will generate two corresponding optically switched fibers 21, 22 simultaneously for a redundant optical line. Output fibers 6 and 7 correspond to the respective reference light beams from input fibers 1 and 20. Information is similarly sent over the light beams into the reference light beams which can contain information about its routing instructions.

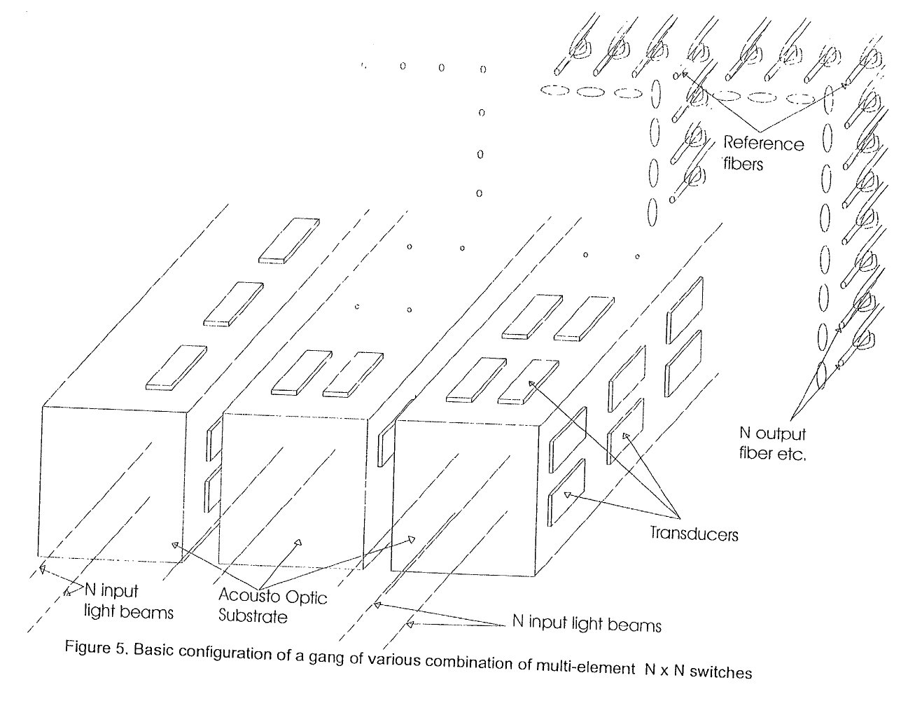

FIG. 5 illustrates a system application whereby a number of optical switching acousto optic devices can be ganged together to further reduce size and further create compactness in the switch. Each individual acousto optic switch device in the gang can be made of an array of transducers along the longitudinal axis of the device, or a double row of transducers along the same face, or multiple rows, or a row or rows of transducers along the adjacent faces or various combinations of transducers to meet system requirements. These combinations of rows of transducers on an individual acousto optic element can be ganged with a new combination of transducers on another adjacent acousto optic element and go on and on until the system requirement is fulfilled.

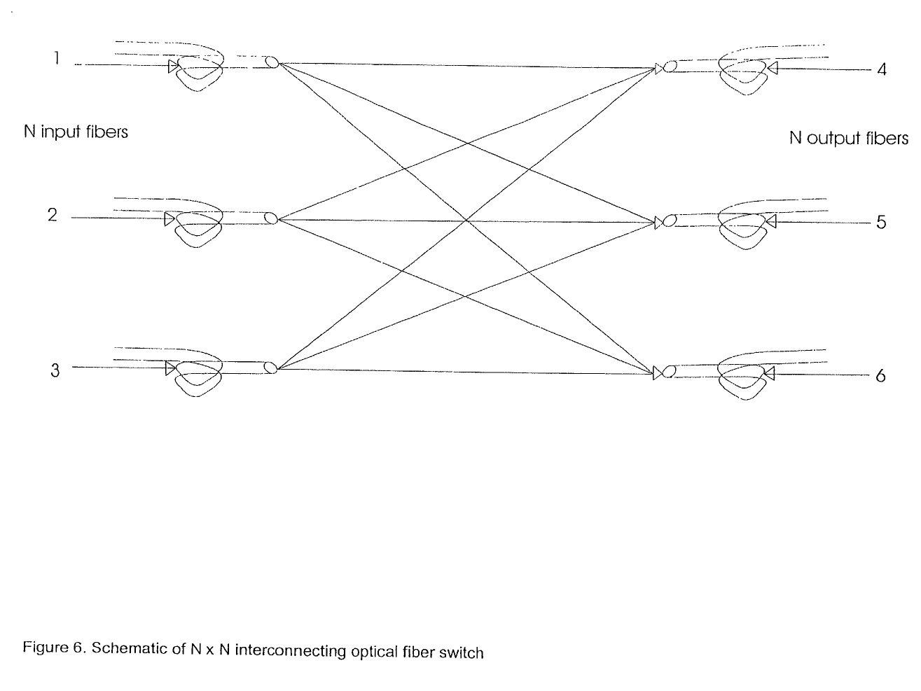

FIG. 6 shows the schematic of connecting random N input fibers to random N output fibers. Light from any input fiber can be randomly directed to any output fiber. Light from multiple input fibers can be directed to the same output fiber or multiple output fibers. Light from a single input fiber can be directed to a single output fiber or multiple output fibers. For example, light from input fiber 1 can be directed to fiber 4 or 5 or 6 or do all of them simultaneously. This is also true for fiber 2 or fiber 3.

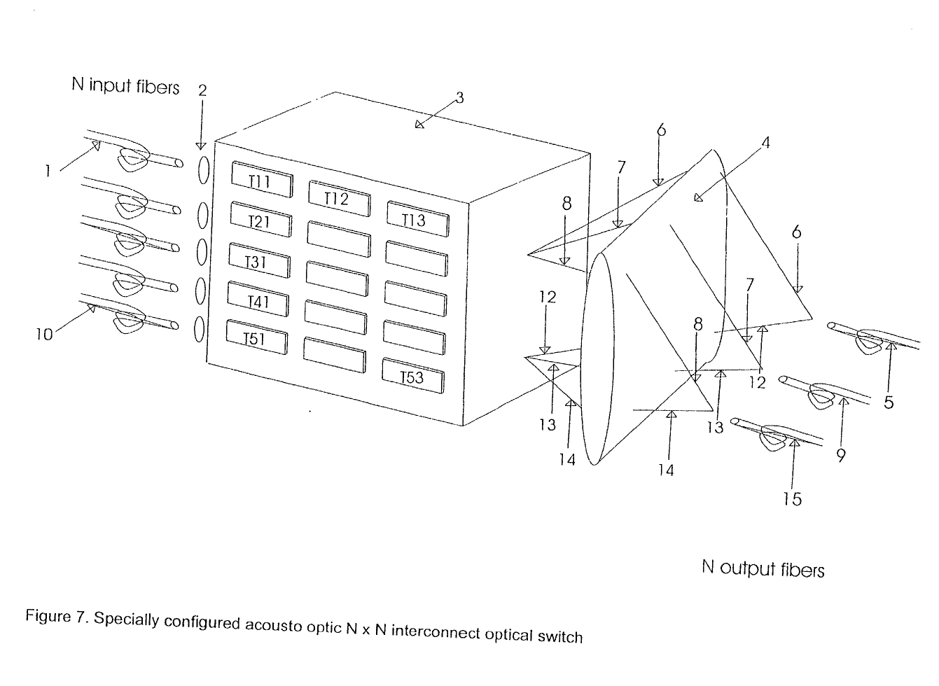

The concept of the N×N optical switch in FIG. 6 can be implemented by using two kinds of novel specially configured multichannel acousto optic devices. In FIG. 7 the first novel acousto optic N×N optical switch will be discussed.

Referring to FIG. 7, the novel N×N optical switch device is made from an acousto optical material 3 with N input fibers 1, etc coupled with a lens 2. The acousto optic device has a multiple array of transducers, T11, T12, T13, etc. and is coupled via a lens 4 to N output fibers 5, etc. as shown in FIG. 7. Light from fiber 1 is Bragg angle adjusted to interact with transducer T11, T12, and T13. If transducer T11 is activated with RF power, light from fiber 1 will be deflected along light path 6 into N output fiber 5. If transducer T12 is “on” and T11 and T13 are “off” then the N input beam 1 will be switched to N output fiber 9 along light path 7. Similarly, if transducer T51 is activated light from N input fiber 10 will follow path 12 into N output fiber 5. Also, if transducer T53 activated light from N input fiber 10 will follow path 14 into N output fiber 15.

Transducers in the same row, T11, T12, etc. will switch light to different positions along the horizontal plane (plane of acousto-optic deflection). Transducers in each column, T11, T21, etc will deflect light along the same vertical planes and by using a set of lenses (ie. cylindrical lens) each of these planes can be focused into a single output fiber. Using this configuration any N input fiber can be connected with any of the N output fibers.

Also along with each corresponding input fiber there is an associated reference light beam. In all these specially configured acousto optic devices, routing information can be placed on the light beam to be detected in the reference light beam either with a detector or a fiber connected to a detector.

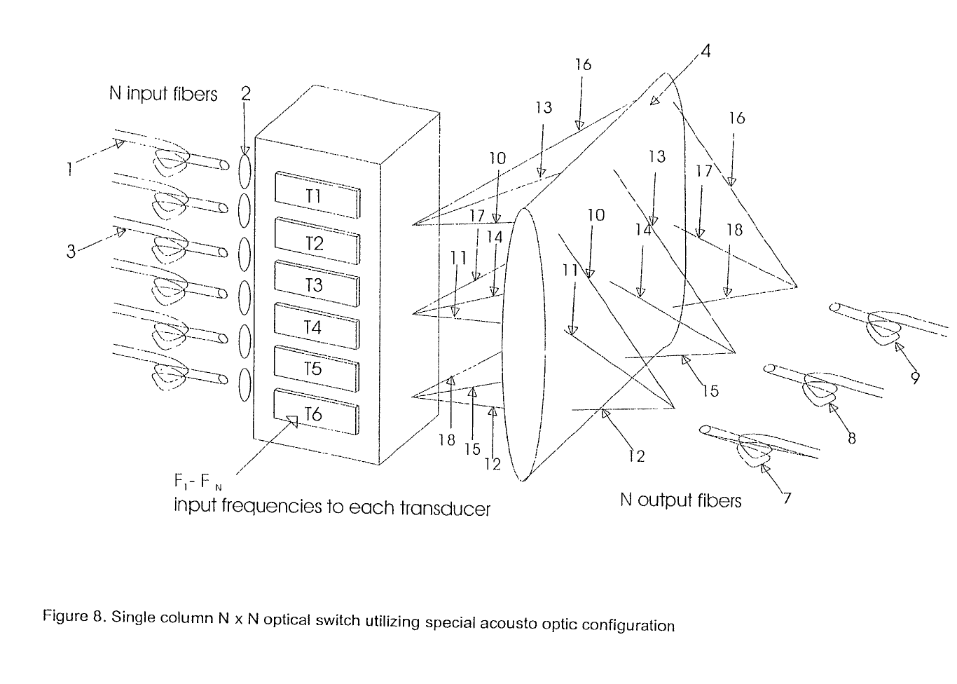

This information from the detector is sent to the control electronics to activate the appropriate N transducer hence causing the light to be routed to a certain N output fiber or fibers. The second type of the N×N optical switch is shown in FIG. 8.

This device is made from an acousto optic material where the acoustic interactions take place with a column piezoelectric transducers. Each transducer is fabricated to operate over a frequency range. Using either a single standard transducer or phased array transducer can do this. The separation angle, θ_{S} between the input beam and the deflected light is defined by the following equation:

sin θ_{S}=λ*f/v

where λ is the optical wavelength, f is the acoustic frequency and v is the acoustic velocity of sound in the acousto optic material.

Each transducer will switch light to a different position along the horizontal plane (plane of acousto-optic deflection). The number of N output fibers will be dependent upon the RF frequency range which the transducers can operate, and the optical aperture along the sound direction. The same RF frequencies applied to any or all transducers will deflect light along the same vertical planes and by using a set of lenses (ie. cylindrical lens). Each of these planes can be coupled into a single fiber. Using this configuration any N input fiber can be interconnected with any of the N output fibers.

In FIG. 8 each transducer can be activated by different frequencies F₁ . . . F_{N}. Light from fiber 1 can interact with the sound generated by transducer T1, light from fiber 3 can interact with sound generated by transducer T2 and so on. If transducer T1 is activated by frequency F₁ the N output light from fiber 1 will be deflected out and will follow path 10 via a lens 4 into a fiber 7. If activated by frequency F₂ the light from fiber 1 will be switched into fiber 8 following path 13. When transducer T3 activated by frequency F₁ light from fiber 3 will be switched into fiber 7 trough path 11. If transducer T3 activated by frequency F₂, the light from fiber 3 will be switched into fiber 8 following light path 14. In summary applying frequency F₁ to any transducer will switch light from any corresponding N input fiber to N output fiber 7, frequency F₂ will switch light to N output fiber 8 and frequency F₃ will switch light to N output fiber 9 . . . . Also along with each corresponding input fiber there is an associated reference light beam. In all these specially configured acousto optic devices, routing information can be placed on the light beam to be detected in the reference light beam either with a detector or a fiber connected to a detector. This information from the detector is sent to the control electronics to activate the appropriate N transducer hence causing the light to be routed to a certain N output fiber or fibers.

Thus, there has been described a novel optical intelligent switch utilizing one-dimensional, two-dimensional and multi-channel acousto-optic devices optically coupled to optical fibers so as to provide an accurate, stable, high performance, high speed means for transferring and controlling the flow of information that has a number of novel features, and a manner of making and using the invention.

Additional embodiments include the following. An optical intelligent switch (“OIS”) comprising one or N input fibers optically coupled to a specially configured one-dimensional acousto optic device with one or N piezoelectric transducers (“PETs”) arranged on the longitudinal face of the device which are activated at a single or multiple radio frequencies (RF) that satisfy the Bragg condition and the output light beams coupled to detectors and or N output fibers. An OIS comprising one or N input fibers optically coupled to a specially configured two- dimensional acousto optic device with one or N piezoelectric transducers arranged on the longitudinal face of the device and one or N PETs arranged on the adjacent longitudinal face of the device which are activated at a single or multiple RF which satisfy the Bragg condition and the output light beams coupled to detectors and or N output fibers. From these specially configured one and two dimensional AODs the output light beams coupled to N output fibers generates a reference light beam and a deflected light beam with RF power applied to a single PET or N PETs which satisfy the Bragg condition thus creating an optical switch. By externally switching electrical energy or RF into one or N PETs light is switched from the input N fiber to the corresponding N output fibers creating a rapid optical light switch. By activating one or more of the N PETs simultaneously with RF power, multiple output N switching can be achieved simultaneously in the same AOD to create a redundant switch. By increasing rows and numbers of N PETs on various faces of the AOD, the number of N output light fibers increases proportionally. In these specially configured AODs routing information can be placed on the light beam to be detected in the reference light beam either with a detector or output fiber connected to a detector whereby this information from reference light beam is sent to control electronics to activate the appropriate N PETs hence causing the light to be routed to a certain output fiber or fibers.

To further reduce size, individual AODs made of an array of N PETs along the longitudinal axis of the device, or a double row of transducers along the same face, or multiple rows, or a row or rows of transducers along the adjacent faces or various combinations of transducers can be ganged together to meet system requirements. These combinations of rows of transducers on an individual acousto optic element can also be ganged with a new combination of transducers on another adjacent acousto optic element and so on until the system requirement is satisfied.

An N×N optical switch is comprised of N input fibers, light beam forming optics coupled to the input and output of a specailly configured AOD with a two dimensional array of N PETs and N output fibers. The beam forming optics between the AOD and one or N output fibers will combine light deflection caused from each N PET column into a corresponding N output fiber and the reference light beam from each input N light beam will be used to carry routing information via a detector or fiber with a detector to create an intelligent optical switch.

An N×N optical switch is comprised of N input fibers, light beam forming optics coupled to the input and output of a specially configured AOD with a one dimensional array of N PETs and N output fibers. The beam forming optics between the AOD and one or N output fibers which will combine light deflection caused from each N PET activated by the same RF value into a corresponding N fiber, and by activating each or any N PET by the same Nth frequency the N input light beam or beams will be switched to the Nth output fiber, and the reference light beam from each input N light beam may be used to carry routing information with a detector or fiber with a detector.

While specific embodiments of the invention have been shown and described in detail to illustrate the application of the principles of the invention, it will be understood that the invention may be embodied otherwise without departing from such principles and that various modifications, alternate constructions, and equivalents will occur to those skilled in the art given the benefit of this disclosure. Thus, the invention is not limited to the specific embodiment described herein, but is defined by the appended claims.

We claim:

1. An optical intelligent switch comprising:
an input fiber optic light source (“FOLS”) coupled via a lens to an acousto optic device (“AOD”),
said AOD, having a longitudinal face and a transverse face, comprising a light receptor, a first piezo-electric acoustic transducer coupled to the transverse face of said AOD, and a crystal responsive to said transducer, said crystal allowing the interaction of input light with sound generated by said transducer so as to cause a deflection of said input light dependent on the sound generated by said transducer,
an RF source coupled to said first transducer,
and an output, comprising either a detector or an optical fiber,
wherein said switch is activated by radio frequencies from said RF source which satisfy the Bragg condition.

2. A switch as in claim 1 wherein said FOLS comprises at least two input fibers.

3. A switch as in claim 1 wherein said output comprises at least one reference light beam and at least one deflected light beam.

4. A switch as in claim 1 further comprising at least a second transducer and at least a second output fiber, each transducer being associated with a specified output fiber, so that power applied to a specific transducer results in light being directed to a specific output fiber.

5. A switch as in claim 4 wherein at least one output fiber is associated with at least two transducers, thereby creating a redundant switch.

6. A switch as in claim 1, further comprising control electronics responsive to information carried in a light source, and wherein said FOLS carries such encoded information.

7. A switch as in claim 7 wherein said encoded information is routing information.

8. A process for controlling an optical intelligent switch comprising the steps of:
providing an input fiber optic light source (“FOLS”) coupled via a lens to an acousto optic device (“AOD”), said AOD, having a longitudinal face and a transverse face, comprising a light receptor, a first piezo-electric acoustic transducer coupled to the transverse face of said AOD, and a crystal responsive to said transducer, said crystal allowing the interaction of input light with sound generated by said transducer so as to cause a deflection of said input light dependent on the sound generated by said transducer,
providing one or more output fibers coupled to said AOD and situated at locations corresponding to the locations where said FOLS would be deflected by various radio frequency (rf) inputs, and
providing an RF source corresponding to the deflection of said FOLS required so as to direct it to the desired output fiber.

9. A process as in claim 8 wherein said deflection is determined by the frequency of said RF source.
